(19) United States
(12) Patent Application Publication
(10) Pub. No.: US 2015/0162691 A1
(43) Pub. Date: Jun. 11, 2015

(54) Socket-Outlet and an Assembly Including a Socket-Outlet

(71) Applicant: Societe D'Exploitation Des Procedes Marechal, Saint-Maurice (FR)

(72) Inventors: Romain Choiselat, Paris (FR); Yanninck Belin, Paris (FR)

(21) Appl. No.: 14/564,395

(22) Filed: Dec. 9, 2014

(30) Foreign Application Priority Data
Dec. 9, 2013 (FR) 1362280

(51) Int. Cl. H01R 13/453; H01R 13/639

(52) U.S. Cl. CPC H01R 13/4532; H01R 13/639

(57) ABSTRACT

A socket-outlet (10) that extends along an axial direction (X) and that includes at least one housing (18c) that is configured to receive a pin (94) of a plug (90), and a safety disk (12) that is movable in turning between a protection position that prevents access to said housing (18c) and a connection position that allows access to said housing (18c). The socket-outlet (10) includes a turning device (12c1, 14, 14a) for turning the safety disk (12), which turning device is configured to co-operate with the plug (90), the turning device bringing the safety disk (12) from the protection position to the connection position during relative axial movement between the socket-outlet (10) and the plug (90) while the plug (90) is engaging in the socket-outlet (10).

### FIELD OF THE INVENTION

The invention relates to a socket-outlet, to a plug, and to an assembly comprising a socket-outlet and a plug.

### STATE OF THE PRIOR ART

Socket-outlets are known that are fitted with respective safety disks so as to avoid any contact with their parts that are active (i.e. live) when said socket-outlet is not connected to a plug. However, connecting such a socket-outlet to a plug requires movements that are complex and not very intuitive, requiring two large-amplitude movements on the part of the user, in particular a turning movement for turning the safety disk, and a movement in translation for actually putting into contact the active (i.e. live) parts of the outlet and of the inlet.

### SUMMARY OF THE INVENTION

In an embodiment, the socket-outlet extends along an axial direction and includes at least one housing that is configured to receive a pin of a plug, and a safety disk that is movable in turning between a protection position that prevents access to said housing and a connection position that allows access to said housing, wherein the socket-outlet includes a turning device for turning the safety disk, which turning device is configured to co-operate with the plug, the turning device bringing the safety disk from the protection position to the connection position during relative axial movement between the socket-outlet and the plug while the plug is engaging in the socket-outlet.

It should be observed that a socket-outlet forms a female portion that may form part of a power connection (in which the socket-outlet is generally secured to a wall or the equivalent), of an extension cord, or of a connector (in which the socket-outlet generally forms part of a mobile socket), while a plug forms a male portion that may form part of a power connection (in which the plug generally forms part of the movable connection), of an extension cord, or of a connector (in which the plug is generally secured to an appliance or the equivalent).

It should also be observed that, in general, a mobile socket comprises a socket-outlet and a handle or cap that is secured to said socket-outlet; a movable connection comprises a plug and a handle or cap that is secured to said plug; an extension cord is an assembly comprising a mobile socket and movable connection; a power connection is an assembly comprising a socket-outlet and a plug; and a connector is an assembly comprising a mobile socket and a plug.

Naturally, the handle or a cap may be incorporated with the socket-outlet or the plug, in which configuration said socket-outlet or plug also forms a mobile socket or a movable connection.

It should be understood that when the safety disk is in the protection position, it is not possible to insert the pin(s) (i.e. electrical connection portion) of a plug into the housing(s) of the socket-outlet. Conversely, when the safety disk is in the connection position, the pin(s) may be inserted into the housing(s). By way of example, the safety disk is movable in a turning movement about the axial direction, the disk being coaxial with the central axis (parallel to the axial direction) of the socket-outlet. Naturally, it should be understood that the safety disk presents a solid shape that presents a predetermined number of through holes through which plug pins may pass, in particular when the disk is in the connection position and when the holes are in alignment with the housings.

The turning device is configured to co-operate with a plug, such that while the socket-outlet is engaging with the plug (or vice versa) along the axial direction, the turning device brings the safety disk into the connection position. Thus, when the user moves the socket-outlet axially towards the plug (or vice versa), the disk is brought from the protection position to the connection position by means of the turning device. Thus, the user provides only a movement in translation to cause the safety disk to turn and to be able to connect the socket-outlet to a plug. The connection kinematics is thus simplified compared to prior-art socket-outlets.

In certain embodiments, the turning device includes a first element selected from among a helical ramp (or first helical ramp) and a lug formed on an axial wall of the safety disk.

It should be understood that the safety disk presents at least one axial wall, the axial wall presenting a shape that is cylindrical or a shape that is an angular portion of a cylinder, for example.

In a first variant, the axial wall presents a helical ramp. By way of example, the helical ramp is formed by a wall of a helical groove formed in the axial wall. The helical ramp is configured to co-operate with a complementary element, e.g. a lug, that bears axially against said helical ramp, thereby causing the safety disk to turn.

In a second variant, the axial wall presents a projecting lug. The lug is configured to co-operate with a complementary element, e.g. a helical ramp, that bears axially against said lug, thereby causing the safety disk to turn.

In certain embodiments, the turning device further includes a drive ring for driving the disk, the second element selected from among the helical ramp (or first helical ramp) and the lug being formed on an axial wall of the drive ring, the second element being configured to co-operate with the first element.

It should thus be understood that when the ramp is formed in an axial wall of the disk, then an axial wall of the drive ring, radially facing the axial wall of the disk, is fitted with a lug that is configured to co-operate with the helical ramp, whereas when a lug is formed on the axial wall of the disk, the axial wall of the drive ring is fitted with the helical ramp. Such a helical ramp and lug system is a robust and reliable system for transforming a movement in translation into a turning movement.

In certain embodiments, the drive ring is movable in translation, or solely/strictly in translation, while the disk is movable in turning, or solely/strictly in turning.

When the drive ring is moved in translation along the axial direction, in particular while the plug is engaging in the socket-outlet, the co-operation between the lug and the helical groove transforms the movement in translation into a turning movement, the turning movement being communicated to the safety disk that thus passes from the protection position to the connection position. Thus, the movements of each element are simplified and reduced to as little as possible, and this makes the socket-outlet more reliable compared to prior-art socket-outlets.

In certain embodiments, the socket-outlet includes an inner body in which the housing is formed, said drive ring co-operating in axial sliding around the inner body, while the safety disk is mounted to turn on a distal end of said body.

The inner body forms the portion of the socket-outlet in which the housing(s) that receive(s) the pin(s) of the plug is/are formed. The safety disk is mounted to turn on the inner body in such a manner as to be capable of preventing or allowing access to the housing(s). The drive ring slides around the inner body when it is moved in translation. By way of example, the inner body presents one or more guides that extend along the axial direction and that each receive a projection that extends radially from the ring, thereby ensuring that the movement of the ring is a movement strictly in translation. Such a movement strictly in translation makes it possible to optimize the transformation of the movement in translation into a turning movement.

In certain embodiments, an abutment of the disk co-operates with the inner body and limits the turning stroke of the disk. By limiting the turning stroke of the disk, said disk is guaranteed to be in continuous co-operation with the drive ring. This is particularly useful when the lug is not engaged in the helical groove, but when alignment of one relative to the other must be preserved ready for a new engagement of one in the other.

In certain embodiments, the socket-outlet includes a blocking device for blocking the safety disk in the protection position.

Such a blocking device makes it possible to ensure that it is not possible to cause the safety disk to pass from the protection position to the connection position other than by causing the socket-outlet to co-operate with the plug. Access to the active portions of the socket-outlet is thus particularly limited, and safety is increased.

In certain embodiments, the blocking device includes a projection that is configured to be engaged in an axial groove, one of the elements selected from among the projection and the axial groove being formed on the protection disk.

It should be understood that when the protection disk, e.g. an axial wall of the protection disk, includes a projection, then a complementary element that forms part of the socket-outlet includes an axial groove that receives the projection and that prevents the disk from turning when the disk is in the protection position, whereas when the disk, e.g. an axial wall of the protection disk, includes the axial groove, then a complementary element that forms part of the socket-outlet includes a projection that is engaged with the groove so as to prevent the disk from turning when the disk is in the protection position. By way of example, an axially movable locking ring presents such an axial groove or projection configured to be engaged with or disengaged from the projection or groove respectively formed in the disk.

By way of example, when the helical ramp (or first helical ramp) of the turning device is formed by a side wall of a helical groove, the axial groove may be formed by an axial termination of said helical groove. Such a termination makes it possible to prevent the disk from turning when the lug is engaged in the termination. Thus, the lug is used both in the turning device, with the lug co-operating with a side wall of the groove that forms the helical ramp so as to cause the disk to turn, and also in the blocking device for blocking the disk, with the lug co-operating in the axial termination so as to prevent the disk from turning.

In certain embodiments, the socket-outlet includes a return device for returning the disk into the protection position for protecting the housing.

By way of example, the return device comprises one or more springs. By way of example, the return device comprises a torsion spring that is mounted on the same axis as the safety disk, the spring returning the disk when the pins are no longer in co-operation with the disk, e.g. during disconnection of the socket-outlet and the plug. In another example, the return device comprises one or more compression springs that push the drive ring in a position in which it holds the disk in the protection position. Thus, when the ring is pressed via the plug, the ring moves in translation from an initial position to a final position that drives the disk from the protection position to the connection position, whereas when the plug is removed, the springs of the return device return the ring to the initial position, which drives the disk to the protection position. By way of example, when the first helical ramp of the turning device is formed by a side wall of a helical groove, the side wall of the groove facing the first ramp forms a second helical ramp that enables the lug to return the disk from the connection position to the protection position.

In certain embodiments, the socket-outlet includes a locking device for locking the plug in engagement.

Such a locking device is particularly advantageous when using the socket-outlet in an industrial setting. By way of example, such a locking device includes a resilient catch that is configured to co-operate with a rib or a projection of the plug. In addition, such a locking device makes it possible to hold the socket-outlet and the plug together, even in the presence of a possible disk return device that exerts a force that tends to eject the plug from the socket-outlet.

In certain embodiments, the socket-outlet includes a holding device for holding the plug engaged, at least in part, in said socket-outlet.

Such a holding device makes it possible to avoid the plug being ejected from the socket-outlet, e.g. when the socket-outlet includes a disk return device. The holding mechanism holds the plug engaged with the socket-outlet in a position such that the electrical connection between the active portions of the outlet and the inlet is broken.

In certain embodiments, the socket-outlet includes an outer casing, said casing presenting an inner wall, the holding device comprising a baffle-forming slideway that is formed on the inner wall.

It should be understood that the slideway guides a runner secured to the plug in such a manner as to accompany the movement of engaging the plug with the socket-outlet, while the slideway blocks the movement of removing the plug from the socket-outlet. By way of example, the slideway is an axial slideway that forms a baffle in azimuth. In this configuration, the baffle causes the plug to turn while it is engaging in the socket-outlet. Naturally, the turning movement is completely separate from the movement required to move the safety disk. Nevertheless, in a variant, it is possible to envisage combining the two movements. While the plug is being removed from the socket-outlet, the baffle in azimuth blocks the plug. A turning movement provided by the user thus makes it possible to disengage the runner from the baffle in azimuth so as to disconnect the inlet and the outlet completely.

An embodiment relates to a plug that extends along an axial direction and that includes a central pin that extends axially, said central pin including an element selected from among a helical ramp and a lug, said element forming an actuator for actuating a turning device for turning a safety disk of a socket-outlet.

Such a plug makes it possible to co-operate with a socket-outlet having a safety disk that presents a central hole that is configured to receive the central pin, the axial wall of the disk that defines the central hole being fitted with the other element selected from among the helical ramp and the lug. It should be observed that the central pin is generally, but not systematically, a pin that is used for ground connection, such a pin being known by the person skilled in the art as the pin that is used for ground continuity or as the ground contact pin. The central pin is generally distinct from the other pins (or peripheral pins) of the plug.

An embodiment relates to an assembly comprising a socket-outlet according to any one of the embodiments of the present description, and to a plug, the plug including an actuator for actuating the turning device for turning the disk during a relative axial movement between the socket-outlet and the plug while the plug is engaging in the socket-outlet.

In certain embodiments, the actuator includes a skirt that extends axially, said skirt being configured to bear against the turning device.

By way of example, the skirt bears against the drive ring while the plug is engaging in the socket-outlet, thereby causing the safety disk to turn.

### BRIEF DESCRIPTION OF THE DRAWINGS

The invention and its advantages can be better understood on reading the following detailed description of various embodiments of the invention given by way of non-limiting example. The description makes reference to the accompanying sheets of figures, in which:

FIG. 1 shows an assembly comprising a socket-outlet and a plug in a first embodiment;

FIG. 2 is an exploded perspective view showing the FIG. 1 socket-outlet;

FIGS. 3A to 3F show the movements of the safety disk while the plug is engaging in the socket-outlet;

FIG. 4 shows an assembly comprising a socket-outlet and a plug in a second embodiment; and

FIG. 5 shows a section view of the safety disk of the second embodiment.

### DETAILED DESCRIPTION OF EMBODIMENTS

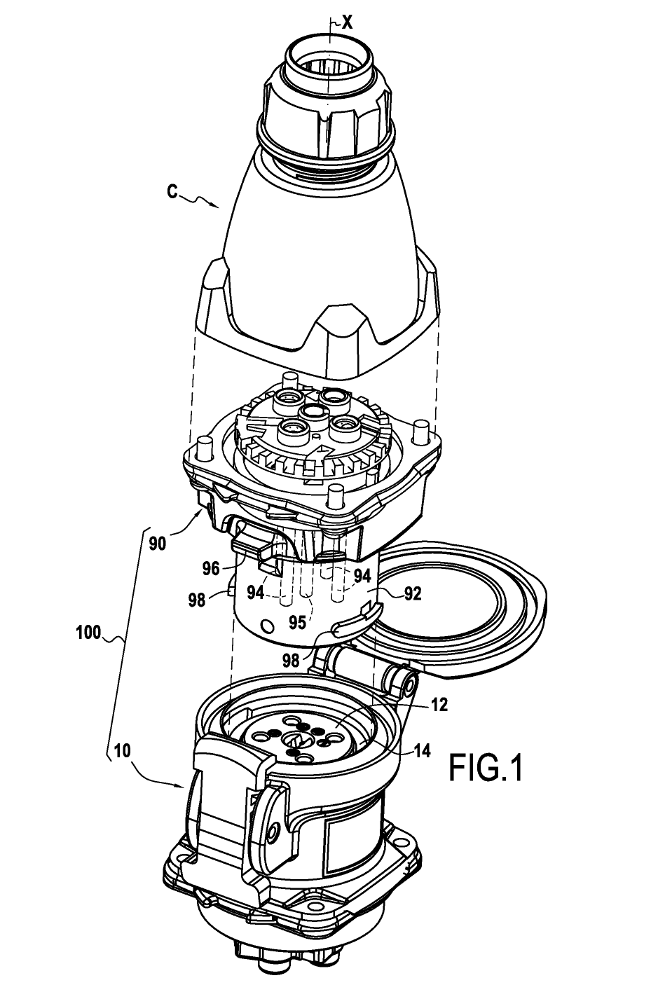

FIG. 1 shows an assembly 100 comprising a socket-outlet 10 and a plug 90. In FIG. 1, it should be observed that a cap C is provided for assembling to the plug 90, the cap C and the plug 90 thus co-operating with each other to form a plug. The socket-outlet 10 extends along an axial direction X and presents a safety disk 12 and a disk drive ring 14 for bringing the safety disk 12 from a protection position to a connection position. The plug 90 presents a skirt 92 that extends axially along the direction X, said skirt 92 being configured to bear against the ring 14 while the plug 90 is engaging in the socket-outlet 10.

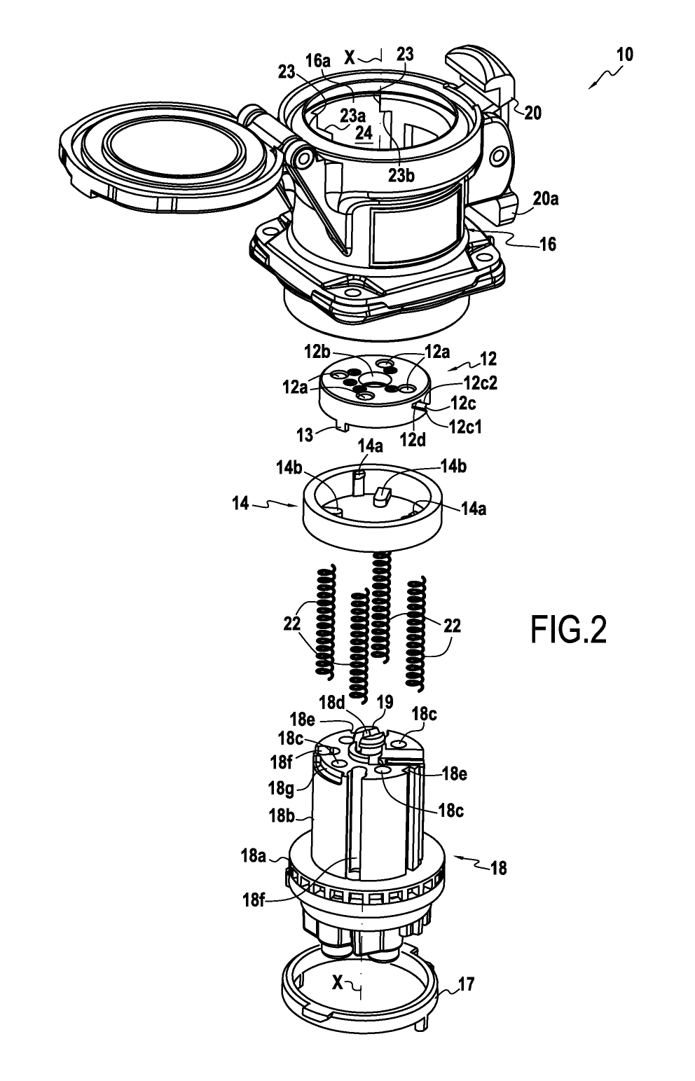

The socket-outlet 10 is described in greater detail below with reference to FIG. 2. The socket-outlet 10 includes an outer casing 16 and an inner body 18 that is mounted in the outer casing 16 and is assembled thereto by means of a locking ring 17. The disk 12 is mounted to turn on the inner body 18 by means of a clip 19 that projects axially from the inner body 18. The disk 12 is arranged at the end of the socket-outlet 10, so as to face the plug 90 when the socket-outlet 10 is connected to the plug 90. In other words, the disk 12 is mounted on the distal end of the inner body 18.

In general, and unless indicated to the contrary, in the present description the adjectives “inside/inner” et “outside/outer” are used with reference to a radial direction, such that an inner (i.e. radially inner) portion of an element is closer to the axis X than an outer (i.e. radially outer) portion of the same element. Thus, an inner side of a part is the side facing or oriented towards the axis X, while an outer side of a part is the side oriented in the opposite direction.

A drive ring 14 is arranged around the inner body 18, co-operating therewith in sliding along the axial direction X. Compression springs 22 are arranged between the inner body 18 and the drive ring 14.

Along the axial direction X, the inner body 18 presents a base portion 18a and a connection portion 18b that forms a distal end of the inner body 18. The connection portion 18b presents a substantially cylindrical shape of axis X. The base portion 18a forms a radial shoulder that co-operates axially with the outer casing 16 so as to mount the inner body 18 within said casing 16.

The inner body 18 presents four housings 18c that are each configured to receive a pin 94—also known as a peripheral pin 94—(cf. FIG. 1). A central housing 18d is configured to receive a central pin 95 (cf. FIG. 1). The pin housings 18c and 18d extend axially.

The inner body 18 presents two axial grooves 18e that extend over substantially the entire axial length of the connection portion 18b. The grooves 18e open radially towards the outside of the body 18, and each opens axially (i.e. opens out axially) in such a manner as to receive a lug 14a of the ring 14 in axial sliding, the lugs 14a extending radially towards the inside of the ring 14. Each lug 14a may thus move axially to engage in, or to disengage from, a groove 18d at the distal end of the inner body 18.

The inner body 18 also presents two axial guides 18f that extend over substantially the entire axial length of the connection portion 18b, each housing a spring 22. The guides 18f open radially outwards and each receives a projection 14b of the ring 14, the projections 14b extending radially towards the inside of the ring 14. In this embodiment, the body 18 presents four guides 18f, while the ring 14 presents four radial projections 14b that are regularly distributed in azimuth (only two projections 14b can be seen in FIG. 2). Each guide 18f and projection 14b pair is thus spaced apart from an adjacent guide 18f and projection 14b pair by approximately 45°.

The inner body 18 presents a channel 18g extending in azimuth that opens out axially into the distal end face of the inner body. The channel 18g receives an abutment 13 of the disk 12. The channel 18g extends angularly in azimuth over approximately 55°.

The disk 12 presents axial through holes 12a, in this embodiment four holes 12a, that are configured to face the orifices of the housings 18c simultaneously. A central axial through-hole 12b is configured to co-operate with the clip 19 by snap fastening, while allowing the disk 12 to turn about the axis X. Thus, the clip 19 forms a pivot pin for the disk 12. The disk 12 is thus prevented from moving in translation by the clip 19, the disk 12 thus being movable only in turning about the clip 19. The central housing 18d is coaxial with the clip 19, the central housing 18d thus not being closable by the disk 12.

In this embodiment, the disk 12 pivots about the axis X. The turning stroke of the disk 12 is limited by the abutment 13 housed in the azimuth channel 18g, against the walls of which the abutment 13 comes into abutment in the azimuth direction. In this embodiment, the maximum azimuth stroke of the disk 12 is thus 55°. The disk 12 is movable in turning between a stable position in which the holes 12a are not in alignment with the housings 18c, the disk thus preventing access to the housings 18c, which position is a protection position, and a position in which the holes 12a are in alignment with the housings 18c, the disk thus allowing access to the housings 18c, which position is a connection position.

The axial outer peripheral wall of the disk 12 presents two helical grooves 12c (a single groove being visible in FIG. 2), each groove receiving a lug 14a of the ring 14. The side wall 12c1 arranged beside the body 18 forms a helical ramp (or first helical ramp). Each helical groove 12c opens (or opens out) axially into the end of the disk facing the body 18. Each groove 12c presents an axial termination 12d at the end of the disk remote from the body 18. Each axial termination 12d forms an axial groove. Each termination 12d is closed axially on the end to be arranged facing the plug 90. Thus, the lugs 14a may slide axially out of the helical grooves 12c at the end beside the inner body 18, but are blocked in the termination 12d on the opposite end.

In the connection position, the helical grooves 12c of the protection disk 12 open out into the axial grooves 18d of the inner body 18. Thus, the lugs 14a can slide continuously from the helical grooves 12c to the axial grooves 18e, and vice versa. This alignment is guaranteed firstly by means of the abutment 13, and secondly by means of the pins 94 that are engaged in the holes 12a when the outlet 10 and the inlet 90 are connected together.

Since the inner radial projections 14b of the ring 14 are permanently engaged in the guides 18f, the ring 14 is prevented from turning. Thus, the ring 14 is movable in sliding along the body 18 in a movement that is strictly axial. Each projection 14b bears against an end of a spring 22, while the opposite end of said spring 22 bears against the body 18. Thus, the springs 22 tend to bring the ring 14 towards the distal end of the socket-outlet 10, and thus bring the lugs 14a against the terminations 12d, thereby causing the springs 22 to tend to bring the disk 12 into the protection position and hold it there. Naturally, it should be understood that when the ring 14 is moved axially, said ring being prevented from turning, the lugs 14a cause the disk 12 to turn by co-operating with the helical grooves 12c.

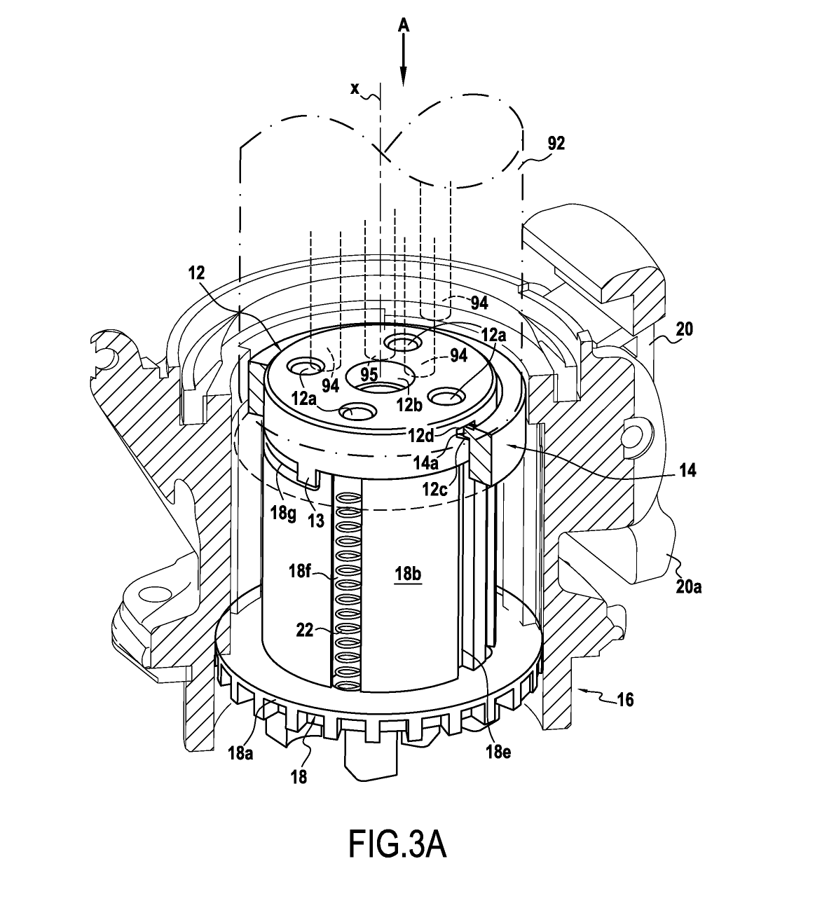

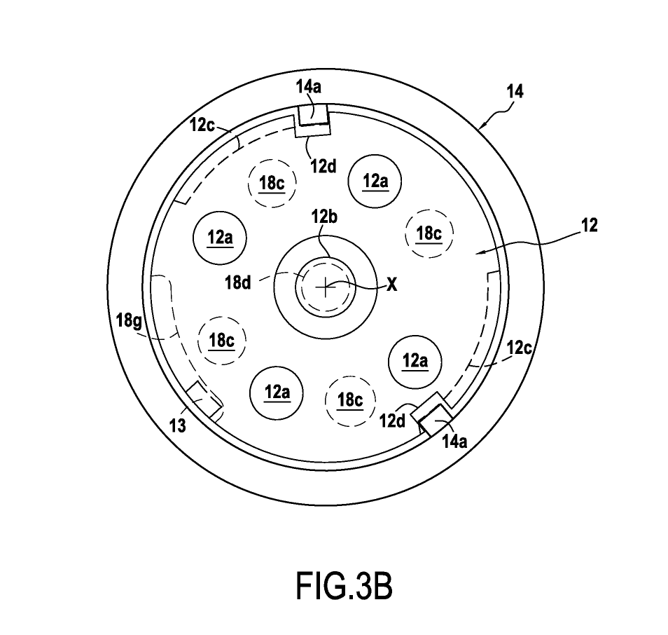

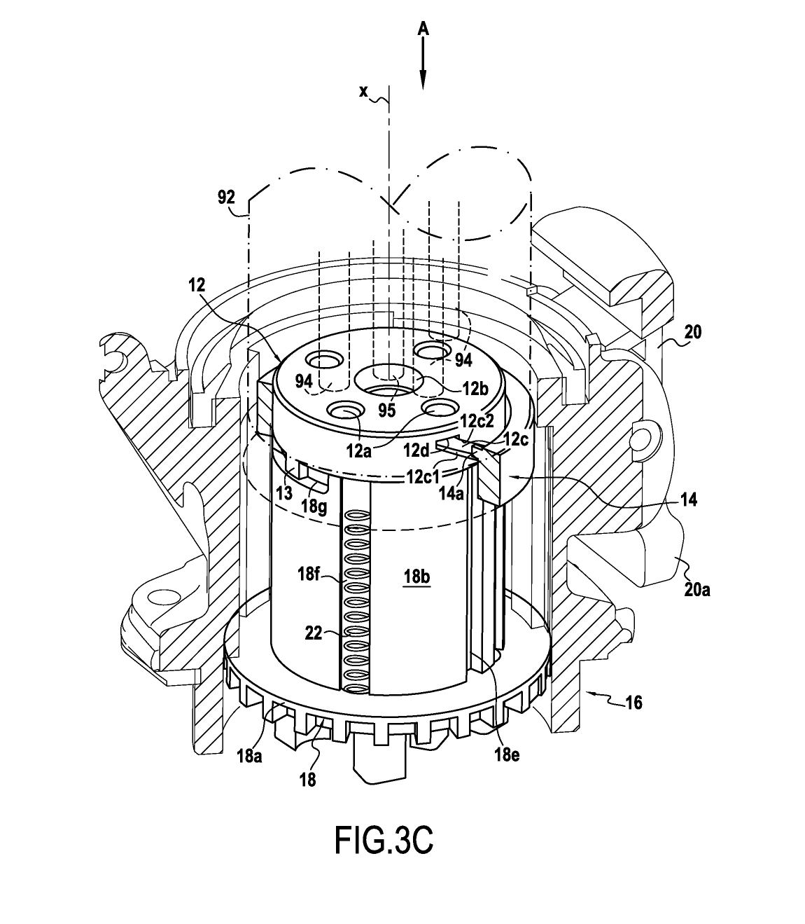

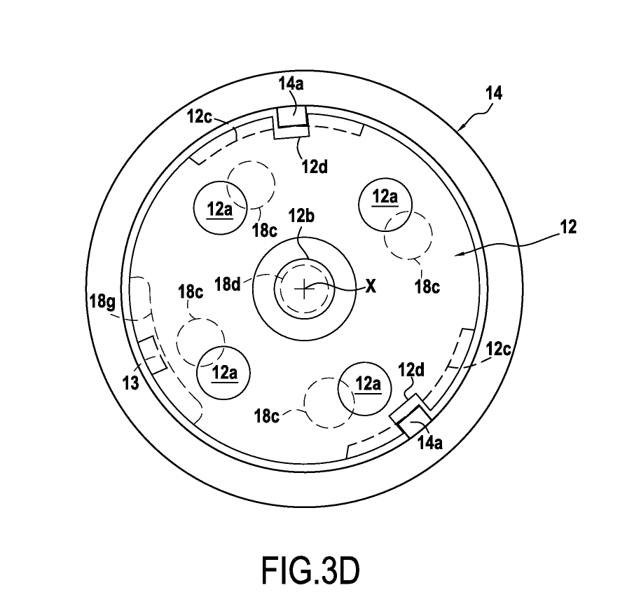

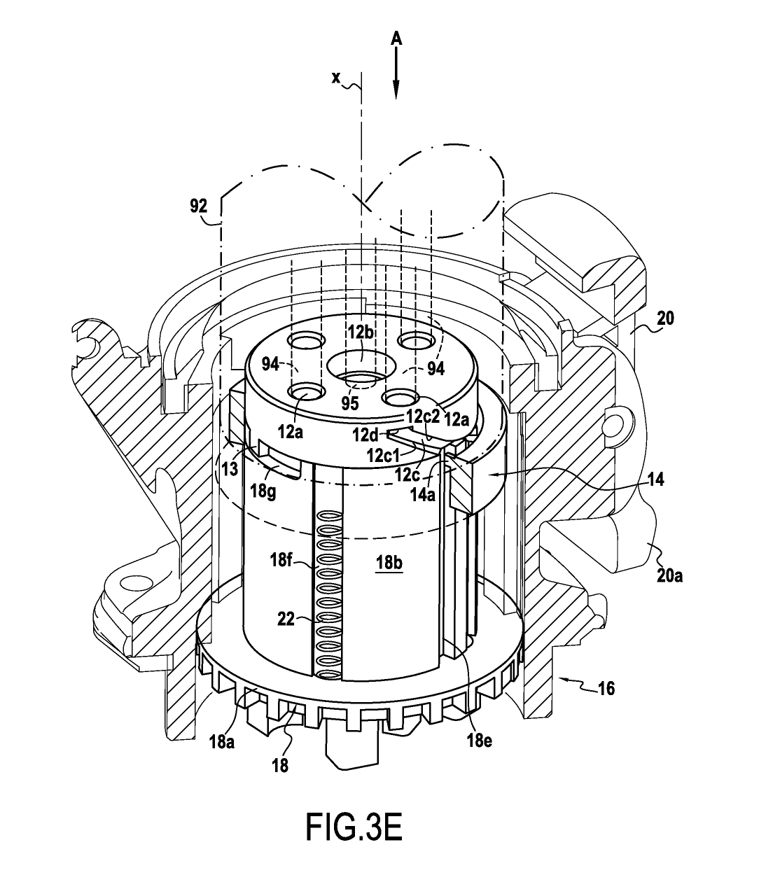

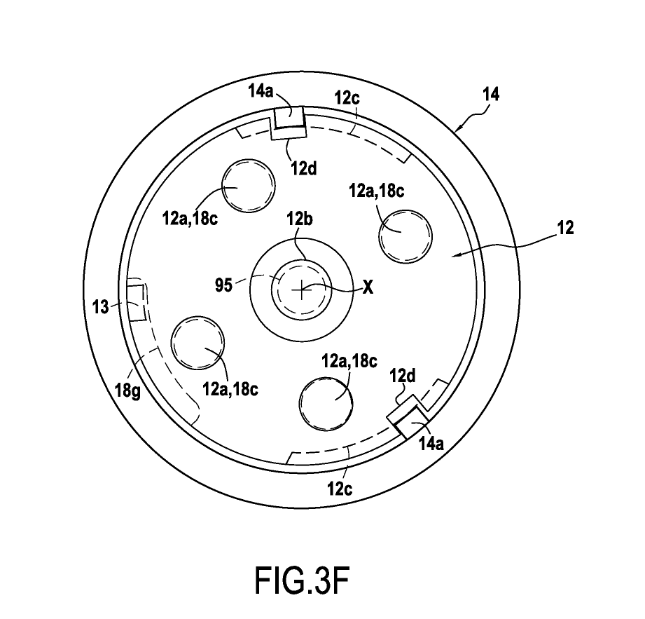

The movements of the disk 12 and of the ring 14 are described below with reference to FIGS. 3A to 3F. In FIGS. 3A, 3C, and 3E, the elements forming part of the socket-outlet 10 are shown by continuous lines, while the elements forming part of the plug 90 are shown by discontinuous lines. FIGS. 3B, 3D, and 3F correspond to a view as seen looking along arrow A in FIGS. 3A, 3C, and 3E respectively. FIGS. 3B, 3D, and 3F show only the ring 14 (in continuous lines), the disk 12, and the body 18, the holes 12a of the disk being shown in continuous lines, while the housings 18c of the body 18 are shown in discontinuous lines. In FIGS. 3A, 3C, and 3D, it should be observed that only three out of four pins 94 can be seen.

In FIG. 3A, the skirt 92 of the plug 90 is approaching the socket-outlet 10. The skirt 92 bears axially against the ring 14, but no axial movement has yet taken place. The skirt 92 thus forms an actuator for actuating the ring 14. The safety disk 12 is in the protection position: the holes 12a of the disk 12 are not in alignment with the housings 18c (cf. FIG. 3B). In this embodiment, in the protection position, the lug 14a is positioned in the termination 12d. Thus, even if an attempt is made to turn the protection disk 12 manually, turning is prevented by means of the axial groove shape of the termination 12d co-operating in abutment in azimuth against the lug 14a. In this embodiment, when the lug 14a is engaged in the termination 12d, they act together to form a blocking device, holding the safety disk 12 in the protection position. Thus, when the lug 14a is engaged in the termination 12d, it is impossible to move the protection disk 12 from its protection position without the assistance of the skirt 92. In this embodiment, it should be observed that the housing 18d is accessible continuously, the housing being reserved for electrical connection to ground, which naturally presents no risk in the event of accidental contact. In this position, it should be observed that the abutment 13 is in abutment, in a first direction in azimuth, with a radial wall of the azimuth channel 18g, which reinforces blocking of the disk 12 in the first direction in azimuth.

In FIG. 3C, the skirt 92 has been moved axially towards the socket-outlet 10 and this has disengaged the lug 14a from the termination 12d and engaged it in the helical portion of the helical groove 12c, thereby causing the disk 12 to turn about the axis X. Thus, in FIGS. 3C and 3D, the disk is in the intermediate position between the protection position and the connection position. The radial projections 14b (not shown in FIG. 3D) thus compress the springs 22.

In FIG. 3E, the skirt 92 has also been moved axially towards the socket-outlet 10 and this has brought the disk 12 into the connection position, thus allowing the pins 94 to penetrate into the housings 18c. Thus, in FIG. 3E, the pins 94 are engaged in the holes 12a, and they begin to penetrate into the housings 18c. Since the helical groove 12c opens out into the axial groove 18e of the body 18, the lug 14a continues its stroke along the axial groove 18e. As shown in FIG. 3F, the holes 12a are in alignment with the housings 18c, the disk 12 being in the connection position. In this position, it should be observed that the abutment 13 is in abutment, in a second direction in azimuth, opposite to the first direction in azimuth, with a radial wall of the azimuth channel 18g, which prevents the disk 12 from turning in the second direction in azimuth. It should thus be understood that in this first embodiment, the helical ramp 12c1, the lug 14a, and the drive ring 14 form a turning device for turning the disk 12, while the skirt forms an actuator for actuating the turning device. In order to finalize the connection of the socket-outlet 10 with the plug 90, the skirt 92 continues to be engaged axially until the radial tab 96 of the plug 90 (cf. FIG. 1) is in engagement with the catch 20 of the socket-outlet 10, the catch 20 forming a locking device. When the catch 20 co-operates with the tab 96, the socket-outlet 10 and the plug 90 are held together.

In order to remove the plug 90 from the socket-outlet 10, the tongue 20a of the catch 20 is pressed, thereby causing the tab 96 to be released, and the springs 22 push the ring 14 axially towards the distal end of the socket-outlet 10. Thus, the plug 90 is pushed axially from the socket-outlet 10 via its skirt 92. Since the springs 22 push the ring 14 axially, the lug 14a passes from the axial groove 18e into the helical groove 12c until it reaches the termination 12d, thereby causing the disk 12 to return from the connection position to the protection position, the lug 14a being driven by the springs 22 to bear against the wall 12c2 of the helical groove 12c, which wall is arranged on the side remote from the body 18 and facing the wall 12c1, the wall 12c2 forming a helical ramp (or second helical ramp). Thus, the springs 22 form a return device that generates movements transmitted between the ring 14, the lug 14a, and the helical ramp 12c2, enabling the disk 12 to be returned to the protection position.

In order to hold the plug 90 engaged, in part, in the socket-outlet 10, e.g. when the tab 96 is released from the catch 20 and when the springs 22 eject the plug 90, the inner wall 16a of the outer casing 16 presents two baffle-forming axial slideways 24 (a single slideway being visible in FIG. 2), each slideway 24 forming a holding device. In this embodiment, each slideway 24 is formed by a groove formed in the thickness of the wall 16a. In a variant, the slideway is formed by a rail. Naturally, the holding device is optional and certain variants do not include a holding device.

The radial walls 23 facing each other in azimuth and defining each slideway 24 present firstly a ramp 23a, and secondly an axial shoulder 23b, the ramp 23a and the shoulder 23b being arranged substantially level with each other in the axial direction, thereby forming a baffle.

The skirt 92 of the plug 90 presents two runners 98 that project radially outwards from the skirt 92. When the skirt 92 penetrates axially into the socket-outlet 10, each runner 98 slides over a ramp 23a, thereby causing the skirt 92 to pivot about the axis X. During this movement, the runners 98 are engaged behind the shoulders 23b. In this embodiment, it should be observed that the turning movement driven by the holding device bearing against the plug 90 has no effect on the turning of the disk 12. In addition, in this embodiment, the plug turns through an angle of small amplitude, about 10°, and has almost no impact on the movement made by the user to plug the plug 90 into the socket-outlet 10. The user senses almost no turning movement.

When it is desired to remove the plug 90 from the socket-outlet 10, the runners 98 come to co-operate axially in abutment against the shoulders 23b, thereby causing the plug 90 to be held in partial engagement with the socket-outlet 10. In order to disengage the plug 90 completely from the socket-outlet 10, the user must disengage the runners 98 from the shoulders by causing the plug 90 to pivot. Once again, the turning movement has no impact on the disk 12. Thus, the movements relative to the holding device and relative to the protection disk are completely decoupled from each other.

In this embodiment, for connection, the user need only provide a single axial movement in translation, by inserting the skirt 92 of the plug 90 into the socket-outlet 10. For disconnecting the inlet from the outlet, the user needs to provide a small turning movement, and a movement in translation for removing the plug 90 from the socket-outlet 10.

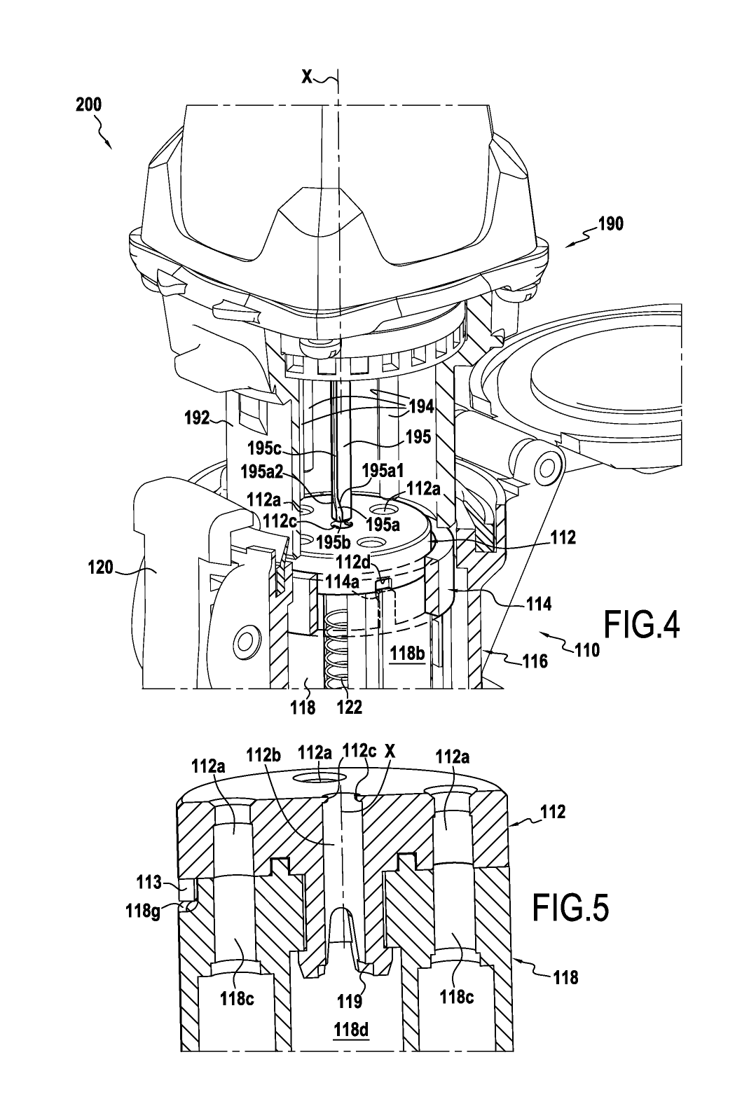

An assembly 200 comprising a socket-outlet 110 and a plug 190 in a second embodiment is described below with reference to FIGS. 4 and 5.

The socket-outlet 110 differs from the socket-outlet 10 in the first embodiment mainly in the safety disk 112 and in the ring 114, which ring, in this embodiment, is not a drive ring but rather a blocking ring for blocking the safety disk 112 in the protection position. The plug 190 differs from the plug 90 in the first embodiment mainly in the central pin 195 which, in this embodiment, has a groove presenting a helical portion. The elements of the second embodiment that are similar to the elements of the first embodiment are not described again, and their reference numbers are merely incremented by 100.

As shown in FIG. 5, the safety disk 112 presents a clip 119 that extends axially and that serves to mount the disk 112 on the inner body 118. The safety disk 112 presents a central hole 112b that extends through the clip 119, the hole 112b being configured to receive the central pin 195 of the plug 190. The wall of the central hole forms an inner axial wall of the safety disk 112, two lugs 112c projecting radially inwards from the axial wall.

Furthermore, in its outer axial wall, the disk 112 presents two axial grooves 112d. When the disk 112 is in the safe position, each of the axial grooves 112d receives a radial projection 114a of the blocking ring 114. The axial groove 112d and the projection 114a form a blocking device for blocking the disk 112 in the protection position. The blocking ring 114 is held in the blocking position with the radial projections 114a engaged in the axial grooves 112d by means of compression springs 122 (a single spring 122 being shown in FIG. 5), each of which co-operates with a projection that is not shown (similar to the projection 14b of the first embodiment) of the blocking ring 114.

On its axial wall, the central pin 195 presents two diametrally-opposite helical grooves 195a (a single groove being visible in FIG. 5), the side wall 195a1, arranged beside the proximal end of the pin 195, of each groove 195a forming a helical ramp 195a1 (or first helical ramp). Two axial groove portions 195b and 195c that are offset in azimuth relative to each other extend axially in line with the azimuth groove 195a. In this way, the axial grooves form axial guides for the lugs 112c. Together, the groove portions 195a, 195b, and 195c form a single groove that opens out axially. Naturally, in a variant, the groove that opens out axially includes only one, two, or more than three groove portions.

While the socket-outlet 110 is engaging with the plug 190, the lugs 112c penetrate into the axial grooves 195b (that open out axially into the vicinity of the distal end of the central pin 195), while the skirt 192 bears against the blocking ring 114, thereby causing the radial projections 114a to be disengaged from the axial grooves 112d, thereby enabling the safety disk 112 to be able to pivot from its protection position.

When the projections 114a are disengaged completely from the grooves 112d, and when the outlet and the inlet continue their engagement, each lug 112c penetrates into a helical groove 195a. In the helical groove 195a, the lug 114a bears against the ramp 195a1, thereby causing the safety disk 112 to turn and pass from the protection position to the connection position. Naturally, in order to be able to turn the disk 112 without said disk interfering with the peripheral pins 194, the central pin 195 presents an axial length that is longer than the length of the peripheral pins 194.

It should thus be understood that in this second embodiment, the lug 112c forms a turning device for turning the disk 112, while the helical ramp 195a1 forms an actuator for actuating the turning device.

When the disk 112 is in the protection position, each lug 112c is engaged in an axial groove 195c, thereby causing the disk to be held in the connection position, while enabling the continued engagement of the outlet and the inlet and the completion of the electrical connection.

While the outlet and the inlet are disconnecting, the same movements take place in reverse, thereby causing each lug 112c to co-operate with the helical ramp 195a2 (or second helical ramp) formed by the side wall of the helical groove 195a, arranged beside the distal end of the pin 195 facing the helical ramp 195a1, and to return the safety disk 112 from the connection position to the protection position.

It should be observed that the springs 122 exert stress on the blocking ring 114 that bears against the skirt 192, and this tends to eject the plug 190 from the socket-outlet 110, the ejection movement enabling the lugs 112c to pass automatically into the helical groove 195a. Thus, the springs 122 form a return device that generates movements transmitted between the ring 114, the skirt 192, the helical ramp 195a2, and the lug 112c, enabling the disk 112 to be returned to the protection position.

Although the present invention is described with reference to specific embodiments, modifications and changes could naturally be made to the embodiments without going beyond the general ambit of the invention as defined by the claims. In particular, individual features of the different embodiments shown and described could be combined together in additional embodiments. Consequently, the description and the drawings should be considered in an illustrative rather than a restrictive sense.

1. A socket-outlet that extends along an axial direction and that includes at least one housing that is configured to receive a pin of a plug, and a safety disk that is movable in turning between a protection position that prevents access to said housing and a connection position that allows access to said housing, the socket-outlet including a turning device for turning the safety disk, which turning device is configured to co-operate with the plug, the turning device bringing the safety disk from the protection position to the connection position during relative axial movement between the socket-outlet and the plug while the plug is engaging in the socket-outlet, the turning device comprising both a first element selected from among a helical ramp and a lug formed on an axial wall of the safety disk, and also a drive ring for driving the disk, the second element selected from among the helical ramp and the lug being formed on an axial wall of the drive ring, the second element being configured to co-operate with the first element.

2. A socket-outlet according to claim 1, wherein the drive ring is movable in translation, while the safety disk is movable in turning.

3. A socket-outlet according to claim 1, including an inner body in which the housing is formed, said drive ring co-operating in axial sliding around the inner body, while the safety disk is mounted to turn on a distal end of said inner body.

4. A socket-outlet according to claim 1, including a blocking device for blocking the safety disk in the protection position.

5. A socket-outlet according to claim 4, wherein the blocking device includes a projection that is configured to be engaged in an axial groove, one of the elements selected from among the projection and the axial groove being formed on the safety disk.

6. A socket-outlet according to claim 1, including a return device for returning the safety disk into the protection position for protecting the housing.

7. A socket-outlet according to claim 1, including a locking device for locking the plug in engagement.

8. A socket-outlet according to claim 1, including a holding device for holding the plug engaged, at least in part, in said socket-outlet.

9. A socket-outlet according to claim 8, including an outer casing, said casing presenting an inner wall, the holding device comprising a baffle-forming slideway that is formed on the inner wall.

10. An assembly comprising a socket-outlet according to claim 1 and a plug, the plug including an actuator for actuating the turning device for turning the safety disk during a relative axial movement between the socket-outlet and the plug while the plug is engaging in the socket-outlet.

11. An assembly according to claim 10, wherein the actuator includes a skirt that extends axially, said skirt being configured to bear against the turning device.
